(19) United States
(12) Patent Application Publication
(10) Pub. No.: US 2020/0212471 A1
(43) Pub. Date: Jul. 2, 2020

(54) MEMBRANE

(71) Applicant: 3M INNOVATIVE PROPERTIES COMPANY, St. Paul, MN (US)

(72) Inventors: Gregory M. Haugen, Edina, MN (US); Daniel P. Meehan, Newport, MN (US)

(21) Appl. No.: 16/634,791

(22) PCT Filed: Jul. 20, 2018
(86) PCT No.: PCT/IB2018/055436

§ 371 Date: Jan. 28, 2020

Related U.S. Application Data
(60) Provisional application No. 62/539,154, filed on Jul. 31, 2017.

(51) Int. Cl. H01M 8/1053; H01M 8/18; H01M 8/106; H01M 8/1067; H01M 8/1086

(52) U.S. Cl. CPC H01M 8/1053; H01M 8/188; H01M 2008/1095; H01M 8/1067; H01M 8/1086; H01M 8/106

(57) ABSTRACT

A cation exchange membrane comprising a supported membrane having first and second opposed major surfaces, wherein the membrane comprises ionomer, and wherein at least one of: the membrane is supported on the first major surface, but unsupported on the second major surface; the cation exchange membrane has a porosity, wherein at least 90 (in some embodiments, at least 95, 96, 97, 98, or even at least 99) percent by volume of the porosity is filled with ionomer, and wherein at least one of the first or second major surfaces of the cation exchange membrane is free of a continuous ionomer layer thereon external to the electrolyte diffusion layer; or the ionomer has a cohesive strength, wherein the ionomer has a maximum annealing temperature that maximizes the cohesive strength of the ionomer, wherein the membrane is supported by at least one support layer, and wherein the support layer has a melting temperature that is less than the maximum annealing temperature of the ionomer. Cation exchange membranes described herein are useful, for example, in redox flow batteries.

### CROSS REFERENCE TO RELATED APPLICATION

This application claims the benefit of U.S. Provisional Patent Application No. 62/539,154, filed Jul. 31, 2017, the disclosure of which is incorporated by reference herein in its entirety.

### BACKGROUND

Supported membranes used in redox flow batteries have different requirements than those needed in fuel cells. In a fuel cell membrane, supported membranes are used to address dimensional stability issues associated with relative humidity (RH) cycling (typically liquid water to less than 20% relative humidity and back to liquid water) and membrane edge failure mechanisms. In flow batteries, however, supported membranes are used to enhance selectivity, mechanical strength, and to provide dimensional stability during part assembly at ambient conditions. Unlike a fuel cell, where the water concentration in the cell can change significantly during operation, in a flow battery the membrane is bathed in a fixed solution so the water concentration only varies by at most a few percent with charge and discharge.

Membranes similar to those reported in PCT Pub. No. WO 2011/149732 A2, published Dec. 1, 2011, have been used in fuel cells for hundreds of thousands of cumulative hours over a variety of accelerated conditions, including deep RH cycling and have not shown mechanical failure corresponding to delamination (see Department of Energy Award No. DE-FG36-07GO17006 “Membranes and MEA's for Dry, Hot Operating Conditions,” Jun. 30, 2011, pp. 63-65). Fuel cell-type supports are designed to minimize dimensional change in the x-y plane, and focus it in the z-direction (i.e., the thickness) of the membrane. Such dimensional change in the z-direction allows for water from changes in RH during fuel cell operation to be absorbed by and desorbed from the membrane. Typically, the thickness of the membrane is in the range of about 15 micrometers to 50 micrometers. However, when the fuel cell-type supported membranes are used in a flow battery they can delaminate at the center of the support layer causing losses in coulombic efficiency.

There are conditions in an aqueous flow battery operation, which are not fully understood, whereby a transient change in water concentration exacerbates the dimensional change in the z-direction resulting in the membrane pulling itself apart at the center. The resulting gap tends to grow at the center of the membrane until the membrane breaks one-half of the gap breaches leaving the membrane half as thick in that spot. Such gap formation is referred to as a “blister.” There is a need to address this type of failure (e.g., extending the time before such failure occurs).

### SUMMARY

In one aspect, the present disclosure provides a cation exchange membrane comprising a supported membrane having first and second opposed major surfaces, wherein the cation exchange membrane comprises ionomer, and wherein at least one of:

the cation exchange membrane is supported on the first major surface, but unsupported on the second major surface;

the cation exchange membrane has a porosity, wherein at least 90 (in some embodiments, at least 95, 96, 97, 98, or even at least 99) percent by volume of the porosity is filled with ionomer, and wherein at least one of the first or second major surfaces of the cation exchange membrane is free of a continuous ionomer layer (i.e., ionomer covers no more than 99 percent (in some embodiments, no more than 95, 90, 75, 50, 25, 10, 5, 1, or even zero percent)), of the area of the ionomer layer, if present, wherein the area is defined by the border dimension(s) of the major surface of the layer (e.g., the length by width for a square or rectangular layer; or circumference of a circular layer) thereon external to the electrolyte diffusion layer; or

the ionomer has a cohesive strength, wherein the ionomer has a maximum annealing temperature that maximizes the cohesive strength of the ionomer, wherein the cation exchange membrane is supported by at least one support layer, and wherein the support layer has a melting temperature that can be less than the maximum annealing temperature of the ionomer.

The present disclosure also provides a method of making a cation exchange membrane described herein, the method comprising:

providing a layer of liquid ionomer on a liner;

providing an electrolyte diffusion layer having first and second major surfaces and an open area porosity in a range from 10 percent to 99 percent (in some embodiments, in a range from 10 percent to 95 percent, 25 percent to 75 percent, 50 percent to 75 percent, or even 60 percent to 70 percent) of the total volume of the electrolyte diffusion layer;

contacting the second major surface of the electrolyte diffusion layer with the layer of liquid ionomer such that a portion of the liquid ionomer penetrates into the electrolyte diffusion layer, and when dried and annealed, provides a major surface of a cation exchange membrane that is free of a continuous ionomer layer (i.e., ionomer covers no more than 99 percent (in some embodiments, no more than 95, 90, 75, 50, 25, 10, 5, 1, or even zero percent)), of the area of the ionomer layer, if present, wherein the area is defined by the border dimension(s) of the major surface of the layer (e.g., the length by width for a square or rectangular layer; or circumference of a circular layer) thereon external to the electrolyte diffusion layer;

at least partially drying the liquid ionomer penetrated into the electrolyte diffusion layer; and

annealing the at least partially dried ionomer to provide the cation exchange membrane.

Cation exchange membranes described herein are useful, for example, as unitized electrode assemblies (UEA). A unitized electrode assembly comprises first and second (optionally porous) electrodes and at least one cation exchange membrane described herein disposed between the first and second electrodes. Unitized electrode assemblies can be used, for example, in redox flow batteries.

### BRIEF DESCRIPTION OF THE DRAWINGS

FIG. 1 is a cross-sectional view of an exemplary cation exchange membrane described herein.

FIG. 2 is a cross-sectional view of another exemplary cation exchange membrane described herein.

FIG. 3 is a cross-sectional view of another exemplary cation exchange membrane described herein.

FIG. 4 is a schematic of an exemplary redox flow battery stack comprising an exemplary cation exchange membrane described herein.

FIG. 5 is a scanning electron microscope (SEM) digital image of a cross-section of the Comparative Example A cation exchange membrane.

FIG. 6 is a SEM digital image of a cross-section of the Example 2 cation exchange membrane.

FIG. 7 is a SEM digital image of a cross-section of the Example 3 cation exchange membrane.

FIG. 8 is a SEM digital image of a cross-section of the Example 4 cation exchange membrane.

### DETAILED DESCRIPTION

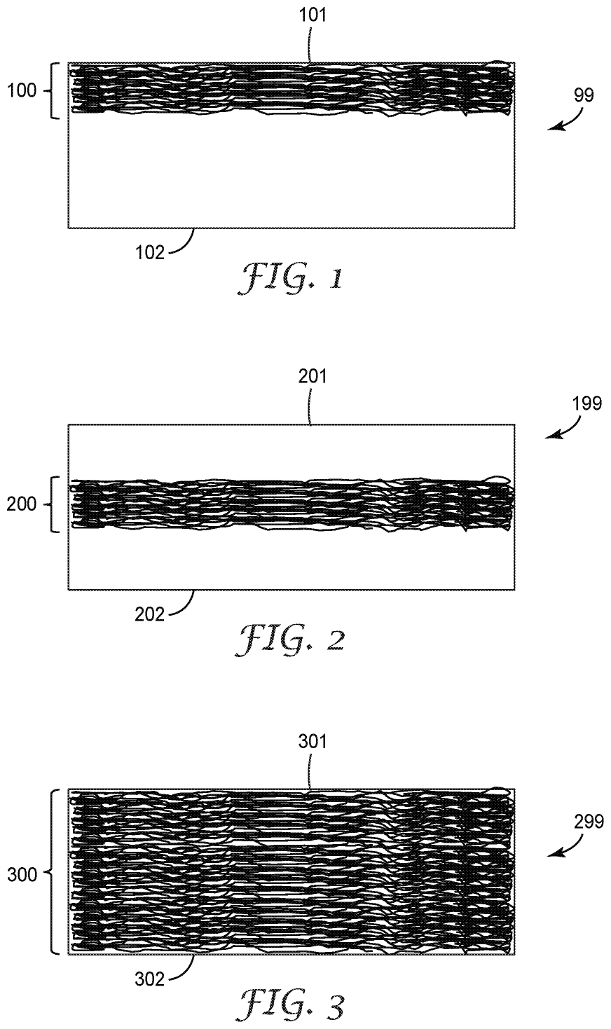

Referring to FIG. 1, exemplary cation exchange membrane 99 comprises supported membrane 100 having first and second opposed major surfaces 101, 102. Cation exchange membrane 99 comprises ionomer, and is supported on first major surface 101, but unsupported on second major surface 102.

Referring to FIG. 2, exemplary cation exchange membrane 199 comprises supported membrane 200 having first and second opposed major surfaces 201, 202. Cation exchange membrane 199 comprises ionomer, and at least one of first or second major surface 101, 102 is free of any continuous ionomer layer.

Referring to FIG. 3, exemplary cation exchange membrane 299 comprises supported membrane 300 having first and second opposed major surfaces 301, 302. Cation exchange membrane 299 comprises ionomer, and first or second major surface 301, 302 are free of any continuous ionomer layer.

In another exemplary embodiment, exemplary cation exchange membrane 299 comprises supported membrane having first and second opposed major surfaces. Cation exchange membrane 299 comprises ionomer. The ionomer has a maximum annealing temperature that maximizes the cohesive strength of the ionomer. Cation exchange membrane 299 is supported by at least one support layer 303. Support layer 303 has a melting temperature that is less than the maximum annealing temperature of the ionomer.

Exemplary ionomers include short side chain (SSC) perfluorosulphonic acid (PFSAs). Such ionomers are commercially available, for example, under the trade designations “NAFION” from DuPont, Wilmington, Del., and “AQUIVION” from Solvay, Brussels, Belgium. In some embodiments, the ionomer comprises at least one of perfluorosulphonic acid (PFSA), perfluoroimide acid (PFIA), perfluoroimide chain extended (PFICE), sulphonated poly ether sulfone, sulphonated polyether ether ketone, perfluoro amide, and blends thereof.

Typically, there is a maximum annealing temperature for each ionomer that maximizes the cohesive strength of the ionomer. The ionomer can be annealed by exposure to a heat source such as in a thermal batch oven or through a continuous oven system with a conveyor belt. The temperature and time can be adjusted to provide the desired level of annealing. A series of temperatures and times can be run to determine the preferred temperature and time for a particular ionomer.

A supported membrane contains a material (e.g., a polymer fiber network) that enhances the strength of the membrane in the x-y plane. A supported membrane is flexible in the z-direction, typically with fibers that are loosely bound if even bound at all. Independent of where the support layer is in the membrane, the modulus, the effective equivalent weight, the water uptake, the boiling swell, and the conductivity will be the same. What differs is the degree of curl, and a membrane with a support to one side can offer advantages in manufacturing for transfer from the casting liner to the subgasket. In the case of annealing the supported membrane beyond the melting point of support polymer, the fiber strength in the x-y direction is destroyed and the swell becomes that of an isotropic blend.

In some embodiments, the support layer, if present, can comprise at least one of a polyurethane, a polyester, a polyamide, a polybenzimidazole, a polyether, a polycarbonate, a polyimide, a polysulphone, a polyphenylene oxide, a polyacrylate, a polymethacylate, a polyolefin, a styrene, a polyvinyl chloride, or a fluorinated polymer. In some embodiments, the support layer comprises at least one of electrospun polymer or expanded polytetrafluoro ethylene (PTFE) polymer.

In some embodiments, the support layer has a basis weight range of 3.2 g/m² to 16 g/m² (in some embodiments, in a range from 4.3 g/m² to 12 g/m², or even, 4.3 g/m² to 8 g/m²).

In some embodiments, the support layer has a porous matrix filled with ionomer. In some embodiments, the ionomer has an equivalent weight in a range from 600 grams per equivalent to 1500 grams per equivalent.

In some embodiments, the final composite membrane (i.e., the membrane includes ionomer and support) has a thickness in a range from 15 micrometers to 50 micrometers (in some embodiments, in a range from 25 micrometers to 50 micrometers).

In another aspect, the present disclosure provides a method of making a cation exchange membrane described herein, the method comprising:

providing a layer of liquid ionomer on a liner;

providing an electrolyte diffusion layer having first and second major surfaces and an open area porosity in a range from 10 percent to 99 percent (in some embodiments, in a range from 10 percent to 95 percent, 25 percent to 75 percent, 50 percent to 75 percent, or even 60 percent to 70 percent) of the total volume of the electrolyte diffusion layer;

contacting the second major surface of the electrolyte diffusion layer with the layer of liquid ionomer such that a portion of the liquid ionomer penetrates into the electrolyte diffusion layer, and when dried and annealed, provides a major surface of a cation exchange membrane that is free of a continuous ionomer layer (i.e., ionomer covers no more than 99 percent (in some embodiments, no more than 95, 90, 75, 50, 25, 10, 5, 1, or even zero percent)), of the area of the ionomer layer, if present, wherein the area is the area defined by the border dimension(s) of the major surface of the layer (e.g., the length by width for a square or rectangular layer; or circumference of a circular layer) thereon external to the electrolyte diffusion layer;

at least partially drying the liquid ionomer penetrated into the electrolyte diffusion layer; and

annealing the at least partially dried ionomer to provide the cation exchange membrane.

Suitable liners include polyimide, polypropylene (including high density polyethylene), and polyester. Techniques for drying and annealing the ionomer are known in the art, and include thermal ovens, heated rolls and microwave treatments.

Cation exchange membranes described herein are useful, for example, as unitized electrode assemblies. A unitized electrode assembly comprises first and second (optionally porous) electrodes and at least one cation exchange membrane described herein disposed between the first and second electrodes. Unitized electrode assemblies can be used, for example, in redox flow batteries.

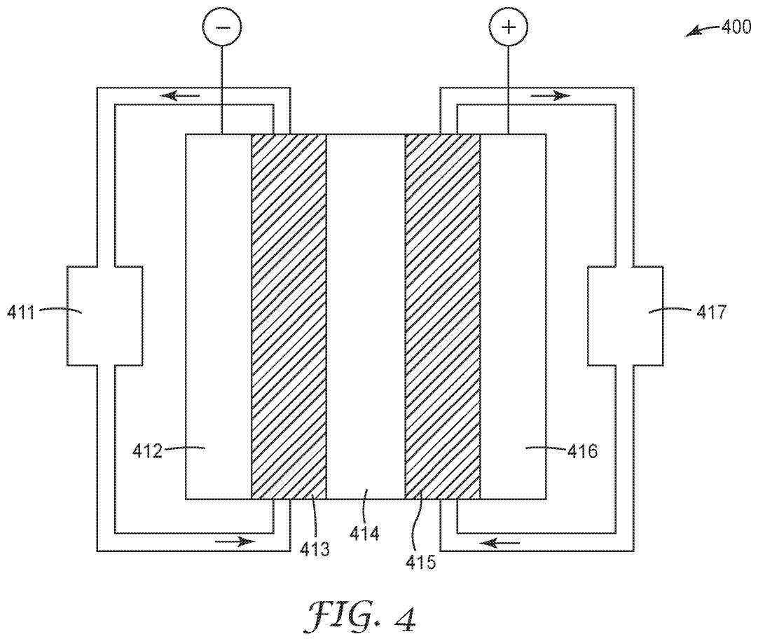

Referring to FIG. 4 exemplary single cell redox flow battery system 400, includes anolyte storage tank 411 for containing an anolyte, current collector plates 412, 416, anode 413, polymeric electrolyte membrane 414, cathode 415, and catholyte storage tank 417 for containing a catholyte. Pumps for the fluid distribution system are not shown.

Negolyte fluid from the negolyte tank is delivered to the electrochemical cell via an negolyte conduit into an negolyte inlet and exits the electrochemical cell via an negolyte outlet and is delivered back to the negolyte tank. Likewise, posolyte fluid is delivered to a posolyte inlet of the electrochemical cell, exits via a posolyte outlet and is delivered back to the posolyte tank. In some embodiments, more than one storage tank is used, for example a tank for storing charged negolyte and a tank for storing discharged negolyte.

In a redox flow battery, the electrolyte membrane separates the electrochemical cell into a positive side and a negative side. The electrolyte membrane is used as a diaphragm allowing selected ions (e.g., H⁺) to transport across the membrane, modulating the ion balance in the cathode and anode, while preventing other ions (such as vanadium ions) of different valences from mixing with each other and discharging the battery.

The membrane and the two electrodes are sandwiched between current collector plates, which optionally have a field flow pattern etched thereon, and then held together such that each layer is in contact, preferably intimate contact, with the adjacent layers.

The negolyte and the posolyte are fluid electrolytes. In one embodiment, the fluid electrolyte is a liquid electrolyte. In one embodiment, the liquid electrolyte is an aqueous solution. The aqueous solution electrolyte includes, for example, an iron-chromium base, titanium-manganese-chromium base, chromium-chromium base, iron-titanium base, or a vanadium base.

In the “charging” mode, power and control elements, connected to a power source, operate to store electrical energy as chemical potential energy in the posolyte and negolyte in the form of a difference in electrical potentials (i.e., a voltage) between the posolyte and the negolyte. The power source can be any power source known to generate electrical power, including renewable power sources, such as wind, solar, and hydroelectric. Traditional power sources, such as combustion, can also be used.

In the discharge mode, the redox flow battery system is operated to transform chemical potential energy stored in the posolyte and negolyte into electrical energy that is then discharged on demand by power and control elements that supply an electrical load.

Referring again to FIG. 4, a single electrochemical cell is shown. To obtain high voltage/power systems, a plurality of single electrochemical cells may be assembled together in series to form a stack of electrochemical cells. Several cell stacks may then be further assembled together to form a battery system. A megawatt-level redox flow battery (RFB) system can be created and generally has a plurality of cell stacks, for example, with each cell stack having more than twenty electrochemical cells. As described for individual electrochemical cells, the stack is arranged with positive and negative current collectors that permit electrons to flow into or out of the cell stack during electrochemical charge and discharge, respectively.

### EXEMPLARY EMBODIMENTS

1A. A cation exchange membrane comprising a supported membrane having first and second opposed major surfaces, wherein the membrane comprises ionomer, and wherein at least one of:
the membrane is supported on the first major surface, but unsupported on the second major surface;
the cation exchange membrane has a porosity, wherein at least 90 (in some embodiments, at least 95, 96, 97, 98, or even at least 99) percent by volume of the porosity is filled with ionomer, and wherein at least one of the first or second major surfaces of the cation exchange membrane is free of a continuous ionomer layer (i.e., ionomer covers no more than 99 percent (in some embodiments, no more than 95, 90, 75, 50, 25, 10, 5, 1, or even zero percent)), of the area of the ionomer layer, if present, wherein the area is defined by the border dimension(s) of the major surface of the layer (e.g., the length by width for a square or rectangular layer; or circumference of a circular layer) thereon external to the electrolyte diffusion layer; or
the ionomer has a cohesive strength, wherein the ionomer has a maximum annealing temperature that maximizes the cohesive strength of the ionomer, wherein the membrane is supported by at least one support layer, and wherein the support layer has a melting temperature that is less than the maximum annealing temperature of the ionomer.
   2A. The cation exchange membrane of Exemplary Embodiment 1A, wherein the support layer comprises at least one of a polyurethane, a polyester, a polyamide, a polybenzimidazole, a polyether, a polycarbonate, a polyimide, a polysulphone, a polyphenylene oxide, a polyacrylate, a polymethacylate, a polyolefin, a styrene, a polyvinyl chloride, or a fluorinated polymer.
   3A. The cation exchange membrane of any preceding A Exemplary Embodiment, wherein the support layer comprises at least one of electrospun polymer or expanded polytetrafluoro ethylene (PTFE) polymer.
   4A. The cation exchange membrane of any preceding A Exemplary Embodiment, wherein the support layer has a basis weight range of 3.2 g/m² to 16 g/m² (in some embodiments, in a range from 4.3 g/m² to 12 g/m², or even, 4.3 g/m² to 8 g/m²).
   5A. The cation exchange membrane of any preceding A Exemplary Embodiment, wherein the support layer has a porous matrix filled with ionomer.
   6A. The cation exchange membrane of Exemplary Embodiment 5A, wherein the ionomer has an equivalent weight in a range from 600 grams per equivalent to 1500 grams per equivalent.
   7A. The cation exchange membrane of any preceding A Exemplary Embodiment, wherein the membrane has a thickness in a range from 15 micrometers to 50 micrometers (in some embodiments, in a range from 25 micrometers to 50 micrometers).
   8A. A unitized electrode assembly comprising first and second porous electrodes and at least one cation exchange membrane of any preceding A Exemplary Embodiment disposed between the first and second porous electrodes.
   9A. A redox flow battery comprising a unitized electrode assembly of Exemplary Embodiment 8A.
   1B. A method of making a cation exchange membrane of any of Exemplary Embodiments 1A to 7A, the method comprising: providing a layer of liquid ionomer on a liner;

providing an electrolyte diffusion layer having first and second major surfaces and an open area porosity in a range from 10 percent to 99 percent (in some embodiments, in a range from 10 percent to 95 percent, 25 percent to 75 percent, 50 percent to 75 percent, or even 60 percent to 70 percent) of the total volume of the electrolyte diffusion layer;

contacting the second major surface of the electrolyte diffusion layer with the layer of liquid ionomer such that a portion of the liquid ionomer penetrates into the electrolyte diffusion layer, and when dried and annealed, provides a major surface of a cation exchange membrane that is free of a continuous ionomer layer (i.e., ionomer covers no more than 99 percent (in some embodiments, no more than 95, 90, 75, 50, 25, 10, 5, 1, or even zero percent)), of the area of the ionomer layer, if present, wherein the area is defined by the border dimension(s) of the major surface of the layer (e.g., the length by width for a square or rectangular layer; or circumference of a circular layer) thereon external to the electrolyte diffusion layer;

at least partially drying the liquid ionomer penetrated into the electrolyte diffusion layer; and

annealing the at least partially dried ionomer to provide the cation exchange membrane.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### EXAMPLES

### Comparative Examples A-H

Comparative Examples A-H (CEx A-CEx H) were prepared as follows, with the specific construction features shown in Table 1, below.

TABLE 1

| | | | Individual | Sup- | | |
|---|---|---|---|---|---|---|
| | | Total | Skin | ported | | |
| | Support | Membrane | Layer | Region | Support | |
| | Polymer | Thick- | Thick- | Thick- | to One | Delami- |
| | Basis | ness, | nesses, | ness, | Side, | nation |
| | Weight, | micro- | micro- | micro- | Yes | Observed, |
| | g/m² | meters | meters | meters | or No | Yes or No |
| CEx A | 4.3 | 25 | 9.5 | 6 | No | Yes |
| CEx B | 8 | 25 | 7.5 | 12 | No | Yes |
| CEx C | 12 | 25 | 5 | 18 | No | Yes |
| CEx D | 16 | 25 | 2.5 | 22 | No | Yes |
| CEx E | 4.3 | 50 | 22.5 | 6 | No | Yes |
| CEx F | 8 | 50 | 20 | 12 | No | Yes |
| CEx G | 12 | 50 | 17.5 | 18 | No | Yes |
| CEx H | 16 | 50 | 15 | 22 | No | Yes |
| CEx I | 4.3 | 20-25 | 8-10 | 6 | No | Yes |
| Ex 1 | 16 | 22 | 0.75 | 22 | No | No |
| Ex 2 | 12 | 17 | 0.75 | 17 | No | No |
| Ex 3 | 4.3 | 25 | ~0/20 | 5 | Yes | No |
| Ex 4 | 4.3 | 25 | 10 | 5 | No | No |

### Support Characterization

The support polymer porous nanofiber mats were an electrospun blend of polyvinylidene fluoride (PVDF) and polyethersulfone (PES) (obtained from Amotech, Inchon, Korea). The molecular ratio of PVDF to PES was 30:70. The basis weights of the nanofiber mats were measured by cutting a 10 cm×10 cm sheet of the selected nanofiber mat and weighing it on a balance. The average basis weight of a group of five 10 cm×10 cm sheets of the material used for each membrane is reported in Table 1, above.

The porosity of each basis weight nanofiber mat was estimated semi-empirically according to the following equation:

Percent Porosity=(1−(weight/(intrinsic density×area×thickness)))×100.

A 10 cm by 10 cm piece of the selected nanofiber mat was folded onto itself with minimal pressing and weighed. The thickness of the 10 cm by 10 cm piece of the nanofiber mat was measured using a micrometer (obtained under the trade designation “TMI 49-16-01 PRECISION MICROMETER” from Testing Machines Inc., Ronkonkoma, N.Y.), with a dead weight pressure of 50 kPa (7.3 psi) and a diameter of standard anvil of 0.63 inch (1.6 cm). The intrinsic density of the nanofiber mat material was 1.493 gram/cm³.

Comparative Examples A-H were made in a roll-to-roll fashion in a sequential two step solution coating process with a “bottom” ionomer solution coated on a carrier liner, followed immediately by a feed-in of a web of polymer support porous nanofiber mat, and subsequently followed by a final “top” ionomer solution coating. The difference in method between each of these Comparative Examples A-H was the coating die pump rates, which resulted in different coating thickness of the individual layers, and the basis weights of the support polymer porous nanofiber mats used, as shown in Table 1, above. The “bottom” coating solution was made from a perfluorosulfonic acid (PFSA) ionomer having an equivalent weight of 825 grams per equivalent (obtained under the trade designation “825 EW” PFSA from 3M Company, St. Paul, Minn.), dissolved at about 35% solids by weight in a mixture of ethanol/water (75/25 by weight). The “top” coating solution was made from the same lot of “825 EW” PFSA by dissolving it at about 21% solids by weight in a mixture of ethanol/water (75/25 by weight). The “bottom” coating solution was coated onto a polyimide liner (obtained under the trade designation “KAPTON HN200” from DuPont, Wilmington, Del.) at a constant flow rate using a coating die and a line speed of about 2 meters per minute, with a target dry thickness determined by the final dry composite thickness minus the equivalent nonporous thickness of the support, calculated from the support polymer porous nanofiber mat basis weight and polymer blend density. The porous polymer nanofiber mat support was laid into the wet polymer on the liner of the bottom coat, then another layer of polymer was coated on top of the nanofiber mat using the “top” solution. The tension of the porous support layer was kept at a minimum, in order to keep it just taunt, allowing the “bottom coat” to wick into the support mat, thus presenting an ionomer-filled support surface for the top coat. The coating line used was obtained under the trade designation “ML200” from Hirano Entec Co., Ltd., Nara, Japan, and had four drying zones arranged sequentially in the down-web direction set to 50° C., 100° C., 120° C., and 145° C., respectively.

### Flow Battery Test Assembly

Membranes were tested as a flow battery cell assembly in triplicate to evaluate the delamination, or lack of delamination, of the membranes. Each membrane was first assembled into a unitized electrode assembly (UEA). The UEA construction consisted of two pieces of heat treated carbon paper (obtained under the trade designation “39AA” from SGL Carbon SE, Wiesbaden, Germany) per side of the membrane (for a total of four carbon paper sheets.) The heat treatment of the “39AA” carbon paper was done in a tube furnace at 400° C. for 48 hours under a constant air flow. The heat treated “39AA” electrodes (˜250 micrometer thickness per piece) had been die cut into four 2.5 cm×2.5 cm squares. Two pieces of 25 micrometer thick polyethylene naphthalate (PEN) subgasket (obtained under the trade designation “TEONEX 1MIL” from Du Pont Teijin Films, Chester, Va.) were die cut in 7.6 cm×7.6 cm squares with a 2.21 cm×2.21 cm hole in the center. Two single 375 micrometer thick polytetrafluoroethylene (PTFE) sheets (obtained under the trade designation “TFV-.015-R12” from Plastics International, Eden Prairie, Minn.) were die cut into gaskets to frame the membrane, one per side, resulting in an approximate compression in the 5 cm² active area of 25% in the assembled flow battery cell.

The UEA was hand assembled in the cell between the two bipolar plates in the following order: PTFE gasket, two pieces of heat treated electrodes (“39AA”) in the square hole in the gasket, then a piece of the PEN subgasket, the membrane under test, another PEN subgasket, and finally the second PTFE gasket framing two more carbon papers. The test fixtures were 5 cm² cells (obtained under the trade designation “5 cm² CELL HARDWARE” from Fuel Cell Technologies, Albuquerque, N. Mex.) and modified for flow battery testing by drilling holes through the end plate to facilitate the use of plastic tubing connection. The graphite flow field components in the Fuel Cell Technologies test fixture was replaced with the same components machined from graphite obtained under the trade designation “TOKAI G347B” from MWI Carbon & Graphite Solutions, Rochester, N.Y.

### Flow Battery Test

The UEAs were tested at room temperature in the modified Fuel Cell Technologies test cell with a single dual-head pump (obtained under the trade designation “KNF 5 KTDCB-4” from KNF Neuberger, Inc., Trenton, N.J.) for pumping the negolyte and posoltye. A block diagram of a redox flow battery is shown in FIG. 4. A multi-channel potentiostat (obtained under the trade designation “MPG-205” from Bio-Logic Science Instruments, Seyssinet-Pariset, France) was used to carry out the test protocol and control the pump. The flow rate of 20 cm³/min per side was maintained, with the negolyte side being inerted by a low nitrogen flow in the negolyte containers. Negolyte and posoltye containers started with 50 cubic centimeters of a vanadium V(4) solution each.

The vanadium V(4) solution was 1.5 M VOSO₄, 2.6 M H₂SO₄ prepared by dissolving 676.19 grams of VOSO₄*xH₂O powder (obtained as vanadyl sulfate hydrate from Sigma Aldrich, St. Louis, Mo.) and 287.2 milliliters of 96.5% sulfuric acid in sufficient 18 mega ohm deionized water to make 2 liters of solution.

A vanadium V(5) solution was made from a portion of the V(4) solution by first charging the battery to 1.8 volt at a current density of 80 mA/cm², at which point the posolyte (the chargeable/dischargeable electrolyte solution for the positive side of the redox flow battery) was removed, having been charged to 90% V(5) and 10% V(4).

Upon the first charging to 1.8 volt at a current density of 80 mA/cm², the two solutions were mixed back together, then poured back into the negolyte and posolyte containers. After that, they were recharged again before entering the test protocol to provide 90% V(5) state of charge solution in the posoltye and 90% V(2) state of charge in the negolyte.

The test protocol consisted of one loop performed twice of the following performance metrics: ten charge/discharge cycles at each of three different current densities [80 mA/cm², 160 mA/cm², and 500 mA/cm²] (yielding coulombic and voltage efficiency values), full spectrum impedance at open circuit at full charge and full discharge, and power curves for determining cell resistance as a function of current density at top of charge and bottom of charge. For Comparative Example 1 (CE1), Example 3 (Ex3), and Example 4 (Ex4), no change was observed in any of these performance metrics greater than the margin of error. All others showed performance changes reflective of the change in membrane thickness and effective equivalent weight of the supported membrane. (Adding a support polymer increases the effective equivalent weight of the resulting membrane, by diluting the ionomer concentration.) At the end of the test, the electrolyte was charged to 1.8 volt across the cell and then the pumps were shut off in order to record the open circuit voltage decay as the cell was allowed to self-discharge by crossover of charged species and/or electronic shorting. After discharging to 0.9 volt, with the pumps still off, the electrolyte in the cell alone was recharged to 1.8 volt then allowed to decay to 0.9 volt again while recording the voltage as a function of time of the decay. This was repeated two more times for a total of four open cell voltage (OCV) decay measurements so that an average value and error bar could be ascribed. The self-discharge time is proportional to the coulombic efficiency and electronic short resistance.

### Accelerated Aging Test

An ex-situ accelerated aging test was conducted on the Comparative Examples A-H supported membranes as follows. The supported membrane was wrapped tightly in overlapping layers around a small diameter glass rod (diameter of 2 millimeters) and held in place with O-rings (obtained under the trade designation “VITON” from Chemours, Wilmington, Del.). The glass rods were 3-5 cm in length. When blistering of a membrane occurred, the blister bubbled out to the air side (as opposed to the liner side) of the coating, independent of whether the air side was facing the glass rod or facing out. The supported membrane samples to be tested were cut in widths of 2-4 cm (but less than the length of the glass rod used) and wrapped around the glass rod, air side out, with approximately four wraps. Some samples were tested with the membrane being air side out and for the linear side in, with no difference in the proclivity to blister. Blisters always occurred towards the air side. If the membrane showed delamination, the delamination would form on every layer of the wrap.

These membrane-wrapped glass rods to be tested were then soaked in a posolyte solution at room temperature for 6 hours. Such posoltye solution was prepared by mixing a portion of the 100% V(4) solution and the (90% V(5) 10% V(4)) together in a volumetric ratio of 50:40 to make a 50% charged vanadium posolyte solution.

After the membrane-wrapped glass rods to be tested were removed from the solution, they were rinsed in de-ionized (DI) water, and then placed in an oven overnight at 85° C. They were then removed from the oven and rinsed again in DI water. The test was repeated (each repeat is one cycle) five times total or until delamination was observed, whichever occurred first. As reported in Table 1, above, delamination was observed for each of Comparative Examples A-H. Typically, visible delamination was observed at the rinse step after annealing in the second cycle, sometimes the 3^{rd} cycle. The delamination appeared as bubbles on the membrane when wet, or as a white deflated balloon on the membrane, with diameters ranging from a few millimeters to nearly a centimeter. Scanning electron microscopy showed clear delamination at the center of the support layer in these bubbles, but delamination was never observed where there was not a bubble.

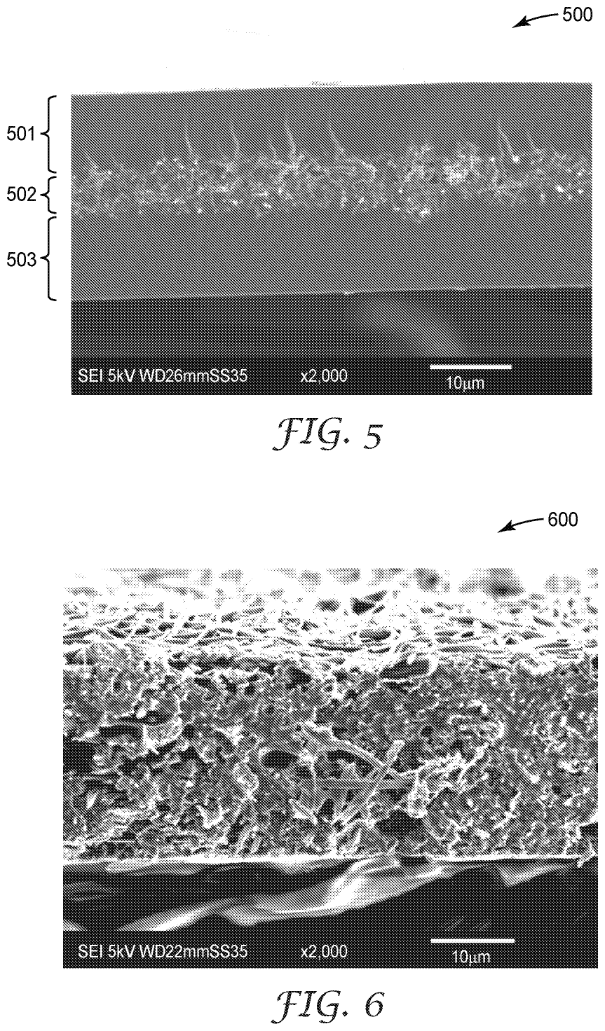

FIG. 5 is SEM digital image of a cross-section of the Comparative Example A cation exchange membrane 500 with top ionomer layer 501, support and ionomer layer 502 and bottom ionomer layer 503.

### Comparative Example I

Comparative Example I was prepared as described for Comparative Examples A-H, except Comparative Example I had a single layer of ionomer coating following the “bottom” layer composition; and the web tension of the support layer feed was increased to a value slightly below the breaking point (maximum tensile strength) of the nanofiber mat in order to pull it into the coating solution to make a supported membrane with a support near the middle of the membrane with two distinct skin layers. The membrane was not as uniform in caliper as others and had a slight undulation in thickness running cross-web and propagating down web. The resulting Comparative Example I was tested using the “Accelerated Aging Test,” and exhibited visible delamination after cycle two of the test, as summarized in Table 1, above.

### Examples 1 and 2 (Ex 1 and Ex 2, respectively)

Examples 1 and 2 were prepared as described for Comparative Examples A-H, except only one layer was coated, using the “bottom” layer composition, the differences between Examples 1 and 2 were the basis weight of the support and the thickness of the single ionomer coating. A cross-sectional schematic of Ex 2 is shown in FIG. 2. Examples 1 and 2 were tested using the “Accelerated Aging Test” and exhibited no delamination after five cycles of that test, as summarized in Table 1, above. FIG. 6 is SEM digital image of a cross-section of the Example 2 cation exchange membrane 600 with support and ionomer.

### Example 3

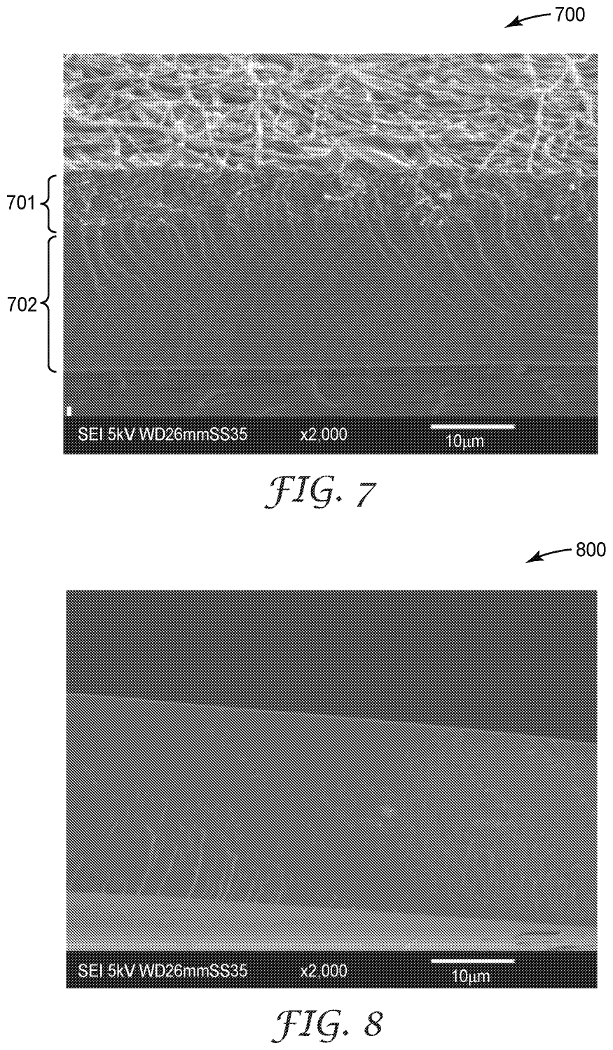

Example 3 was prepared as described for Comparative Examples A-H, except only the “bottom” coating layer was used, and the support layer was feed and the “bottom” coating wicked into the pores of the mat. This produced an asymmetric membrane having essentially no “skin layer” on the air side, although the coating solution tended to wick up onto the exposed mat fibers on the air side. This left the air side somewhat rough and non-level, due to the exposed lightly-coated nanofibers and sunken spans of polymer on the membranes upper surface. Example 3 was tested using the “Accelerated Aging Test” and exhibited no delamination after five cycles of that test, as summarized in Table 1, above. FIG. 7 is SEM digital image of a cross-section of the Example 3 cation exchange membrane 700 with support and ionomer layer 701 and ionomer only layer 702.

### Example 4

For Example 4, a 10 cm×20 cm piece of the CEx A roll good was annealed in a batch oven (obtained as Model LFD1-42-3 from Despatch Industries, Inc., Minneapolis, Minn.) for 30 minutes at 200° C. The appearance of the membrane changed with the melting of the fibers from its original whitish color to become transparent. Example 4 was tested using the “Accelerated Aging Test” and exhibited no delamination after five cycles of that test, as summarized in Table 1, above. FIG. 8 is SEM digital image of a cross-section of the Example 4 cation exchange membrane 800.

Foreseeable modifications and alterations of this disclosure will be apparent to those skilled in the art without departing from the scope and spirit of this invention. This invention should not be restricted to the embodiments that are set forth in this application for illustrative purposes.

1. A cation exchange membrane comprising a supported membrane having first and second opposed major surfaces, wherein the cation exchange membrane comprises ionomer, and wherein at least one of:
the cation exchange membrane is supported on the first major surface, but unsupported on the second major surface;
the cation exchange membrane has a porosity, wherein at least 90 percent by volume of the porosity is filled with ionomer, and wherein at least one of the first or second major surfaces of the cation exchange membrane is free of a continuous ionomer layer thereon external to the electrolyte diffusion layer; or
the ionomer has a cohesive strength, wherein the ionomer has a maximum annealing temperature that maximizes the cohesive strength of the ionomer, wherein the cation exchange membrane is supported by at least one support layer, and wherein the support layer has a melting temperature that is less than the maximum annealing temperature of the ionomer.

2. The cation exchange membrane of claim 1, wherein the support layer comprises at least one of a polyurethane, a polyester, a polyamide, a polybenzimidazole, a polyether, a polycarbonate, a polyimide, a polysulphone, a polyphenylene oxide, a polyacrylate, a polymethacrylate, a polyolefin, a styrene, a polyvinyl chloride, or a fluorinated polymer.

3. The cation exchange membrane of claim 1, wherein the support layer comprises at least one of electrospun polymer or expanded polytetrafluoro ethylene polymer.

4. The cation exchange membrane of claim 1, wherein the support layer has a basis weight range of 3.2 g/m² to 16 g/m².

5. The cation exchange membrane of claim 1, wherein the support layer has a porous matrix filled with ionomer.

6. The cation exchange membrane of claim 5, wherein the ionomer has an equivalent weight in a range from 600 grams per equivalent to 1500 grams per equivalent.

7. The cation exchange membrane of claim 1, wherein the membrane has a thickness in a range from 15 micrometers to 50 micrometers.

8. A unitized electrode assembly comprising first and second porous electrodes and at least one cation exchange membrane of claim 1 disposed between the first and second porous electrodes.

9. A redox flow battery comprising a unitized electrode assembly of claim 8.

10. A method of making a cation exchange membrane of claim 1, the method comprising:
providing a layer of liquid ionomer on a liner;
providing an electrolyte diffusion layer having first and second major surfaces and an open area porosity in a range from 10 percent to 99 percent of the total volume of the electrolyte diffusion layer;
contacting the second major surface of the electrolyte diffusion layer with the layer of liquid ionomer such that a portion of the liquid ionomer penetrates into the electrolyte diffusion layer, and when dried and annealed, provides a major surface of a cation exchange membrane that is free of a continuous ionomer layer thereon external to the electrolyte diffusion layer;
at least partially drying the liquid ionomer penetrated into the electrolyte diffusion layer; and
annealing the at least partially dried ionomer to provide the cation exchange membrane.
